(19) United States
(12) Patent Application Publication
(10) Pub. No.: US 2012/0290191 A1
(43) Pub. Date: Nov. 15, 2012

(54) ABNORMALITY DETERMINATION APPARATUS FOR INTERNAL COMBUSTION ENGINE

(75) Inventor: Yukio Kobayashi, Kasugai-shi (JP)

(73) Assignee: Toyota Jidosha Kabushiki Kaisha, Toyota-shi (JP)

(21) Appl. No.: 13/467,678

(22) Filed: May 9, 2012

(30) Foreign Application Priority Data
May 12, 2011 (JP) 2011-107264

(51) Int. Cl. G06F 11/30; F02D 41/26; F02D 28/00

(52) U.S. Cl. 701/102; 701/99

(57) ABSTRACT

An abnormality determination apparatus for an internal combustion engine having a plurality of cylinders includes: a fluctuation increasing unit that increases a fluctuation in output shaft rotation speed of the internal combustion engine; and a determination unit that determines whether there is a variation in air-fuel ratio among the plurality of cylinders based on the fluctuation increased by the fluctuation increasing unit.

### INCORPORATION BY REFERENCE

The disclosure of Japanese Patent Application No. 2011-107264 filed on May 12, 2011 including the specification, drawings and abstract is incorporated herein by reference in its entirety.

### BACKGROUND OF THE INVENTION

1. Field of the Invention

The invention relates to an abnormality determination apparatus for an internal combustion engine and more particularly, to a technique for in an internal combustion engine having a plurality of cylinders, determining whether there is a variation in air-fuel ratio among the cylinders.

2. Description of Related Art

Generally, an internal combustion engine mounted on a vehicle includes a plurality of cylinders. In many cases, an injector is provided cylinder by cylinder. Thus, when only part of the injectors does not operate normally, the air-fuel ratio varies among the cylinders. In the internal combustion engine, fuel is combusted in each cylinder in a predetermined sequence, so, when the air-fuel ratio is not uniform, torque obtained by combustion of fuel can vary among the cylinders, that is, among crank angles. In addition, as the air-fuel ratio increases (becomes leaner) only in part of the cylinders, misfire may occur only in the part of the cylinders. As a result, a fluctuation in the rotation speed of the output shaft of the internal combustion engine may increase.

As one method of detecting such an abnormality, Japanese Patent Application Publication No. 2006-233800 (JP 2006-233800 A) describes in claim 7, and the like, that the combustion state of an internal combustion engine is changed in a direction to become a good state and then misfire determination is carried out on the basis of a rotation fluctuation.

However, when the combustion state of the internal combustion engine has been changed into a good state, the combustion state also improves in the cylinder of which the combustion state has been deteriorated, for example, because a desired air-fuel ratio cannot be obtained. This reduces the difference between a torque obtained in the combustion stroke of each cylinder of which the combustion state has been deteriorated and a torque obtained in the combustion stroke of each cylinder of which the combustion state has been good, that is, the cylinder having no abnormality in air-fuel ratio. By so doing, a rotation fluctuation is reduced, and, as a result, it may be difficult to determine whether there is an abnormality in air-fuel ratio on the basis of the rotation fluctuation.

### SUMMARY OF THE INVENTION

The invention provides an abnormality determination apparatus for an internal combustion engine, which accurately determines whether there is an abnormal variation in air-fuel ratio among the cylinders.

An aspect of the invention provides an abnormality determination apparatus for an internal combustion engine having a plurality of cylinders. The abnormality determination apparatus includes: a fluctuation increasing unit that increases a fluctuation in output shaft rotation speed of the internal combustion engine; and a determination unit that determines whether there is a variation in air-fuel ratio among the plurality of cylinders based on the fluctuation increased by the fluctuation increasing unit.

With this configuration, a rotation fluctuation that occurs because of a nonuniform air-fuel ratio among the cylinders is further increased when it is determined whether there is a variation in air-fuel ratio among the plurality of cylinders. This increases the difference between a rotation fluctuation at the time when the air-fuel ratio is uniform and a rotation fluctuation at the time when the air-fuel ratio is not uniform. As a result, a phenomenon that occurs because of a variation in air-fuel ratio among the cylinders is made further remarkable to thereby make it possible to further accurately determine whether there is a variation in air-fuel ratio among the cylinders.

### BRIEF DESCRIPTION OF THE DRAWINGS

Features, advantages, and technical, and industrial significance of exemplary embodiments of the invention will be described below with reference to the accompanying drawings, in which like numerals denote like elements, and wherein:

FIG. 1 is a schematic view that shows a hybrid vehicle according to an embodiment of the invention;

FIG. 2 is a graph that shows the locus of an engine torque and an engine rotation speed, along which fuel economy is appropriate, according to the present embodiment;

FIG. 3 is a graph that shows the amount of electric power charged to a drive battery and the amount of electric power discharged from the drive battery according to the present embodiment;

FIG. 4 is a view that shows an engine according to the present embodiment;

FIG. 5 is a graph that shows a fluctuation in engine rotation speed according to the present embodiment;

FIG. 6 is a flow chart that shows processes executed by an engine ECU according to the present embodiment; and

FIG. 7 is a graph that shows a fluctuation in engine rotation speed, which varies with ignition timing, according to the present embodiment.

### DETAILED DESCRIPTION OF EMBODIMENTS

Hereinafter, an embodiment of the invention will be described with reference to the accompanying drawings. In the following description, like reference numerals denote the same components. Those names and functions are also the same. Thus, the detailed description thereof is not repeated.

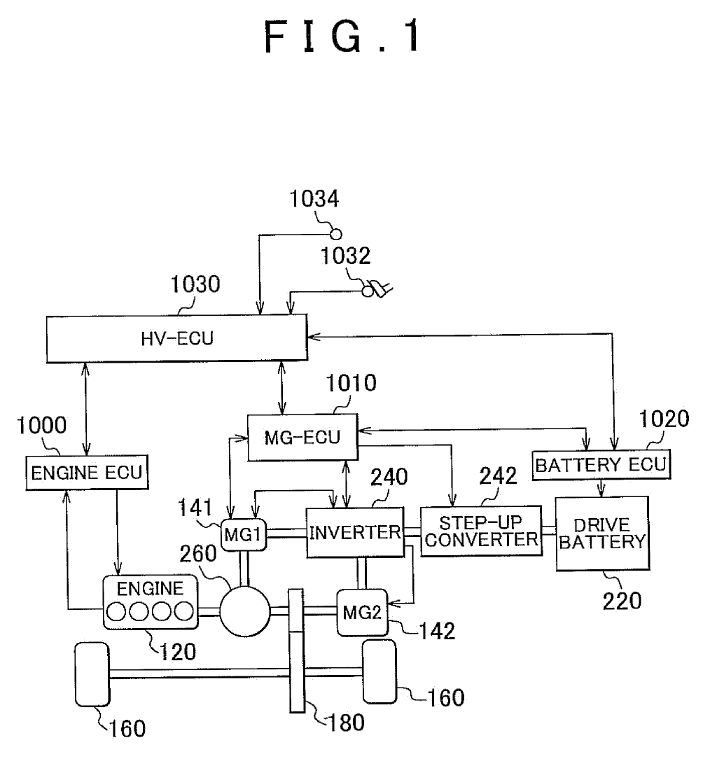

A hybrid vehicle, which is an example of a vehicle according to the embodiment of the invention, will be described with reference to FIG. 1. Note that the aspect of the invention may be applied to a vehicle other than the hybrid vehicle.

The hybrid vehicle includes an internal combustion engine (hereinafter, simply referred to as engine) 120, a first motor generator 141 and a second motor generator 142. The engine 120 may be a gasoline engine or a diesel engine, and includes a plurality of cylinders. For example, the engine 120 and the second motor generator 142 are used as driving sources. That is, the hybrid vehicle runs using driving force from at least any one of the engine 120 and the second motor generator 142. Note that the first motor generator 141 and the second motor generator 142 each function as a generator or function as a motor on the basis of the running state of the hybrid vehicle.

The hybrid vehicle is further equipped with a reduction gear 180, a power split mechanism 260, a drive battery 220, an inverter 240, a step-up converter 242, an engine electronic control unit (engine ECU) 1000, an MG-ECU 1010, a battery ECU 1020 and an HV-ECU 1030. The engine ECU 1000, the MG-ECU 1010, the battery ECU 1020 and the HV-ECU 1030 are configured so as to be able to transmit or receive signals to or from one another.

The reduction gear 180 transmits driving force, generated by the engine 120, the first motor generator 141 and the second motor generator 142, to drive wheels 160, or transmits driving force from the drive wheels 160 to the engine 120, the first motor generator 141 and the second motor generator 142.

The power split mechanism 260 distributes driving force generated by the engine 120 to two paths, that is, the first motor generator 141 and the drive wheels 160. For example, a planetary gear is used for the power split mechanism 260. The engine 120 is coupled to a planetary carrier. The first motor generator 141 is coupled to a sun gear. The second motor generator 142 and an output shaft (drive wheels 160) are coupled to a ring gear. By controlling the rotation speed of the first motor generator 141, the power split mechanism 260 may function as a continuously variable transmission.

The drive battery 220 stores electric power for driving the first motor generator 141 and the second motor generator 142. The inverter 240 converts direct current of the drive battery 220 to alternating current or converts alternating current of the first motor generator 141 and the alternating current of the second motor generator 142 to direct current. The step-up converter 242 converts voltage between the drive battery 220 and the inverter 240.

The engine ECU 1000 controls the engine 120. The MG-ECU 1010 controls the first motor generator 141, the second motor generator 142, the battery ECU 1020 and the inverter 240 on the basis of the state of the hybrid vehicle. The battery ECU 1020 controls the step-up converter 242 and the charge and discharge states of the drive battery 220.

The HV-ECU 1030 manages the engine ECU 1000, the MG-ECU 1010 and the battery ECU 1020 to control the overall hybrid system such that the hybrid vehicle can operate in the most efficient way.

Note that, in FIG. 1, the ECUs are separately formed; instead, two or more ECUs may be formed as an integrated ECU (for example, an ECU that integrates the engine ECU 1000, the MG-ECU 1010 and the HV-ECU 1030 may be used).

When the efficiency of the engine 120 is low, such as when the vehicle starts and when the vehicle is running at a low speed, the hybrid vehicle is controlled so as to run using only driving force from the second motor generator 142.

When the vehicle runs normally, the hybrid vehicle is controlled so as to run using driving force from both the engine 120 and the second motor generator 142. For example, the drive wheels 160 are driven by one of the driving forces into which the driving force of the engine 120 is split by the power split mechanism 260. The first motor generator 141 is driven by the other one of the split driving forces so as to generate electric power. The second motor generator 142 is driven using electric power generated by the first motor generator 141. By so doing, the engine 120 is assisted by the second motor generator 142.

When the vehicle runs at a high speed, electric power from the drive battery 220 is supplied to the second motor generator 142 to increase the output of the second motor generator 142 so as to add driving force to the drive wheels 160. When the vehicle decelerates, the second motor generator 142 driven by the drive wheels 160 functions as a generator to regenerate electric power. The regenerated electric power is stored in the drive battery 220.

When the state of charge (SOC) of the drive battery 220 is low, the output power of the engine 120 is increased to increase the amount of electric power generated by the first motor generator 141. The drive battery 220 is charged with electric power generated by the first motor generator 141.

In the present embodiment, the HV-ECU 1030 sets a target power that includes a power (power calculated as a product of torque and rotation speed) required for the hybrid vehicle to run, the rate of charge to the drive battery 220, and the like. The power required for the hybrid vehicle to run is, for example, determined on the basis of an accelerator operation amount detected by an accelerator position sensor 1032 and a vehicle speed detected by a vehicle speed sensor 1034. Note that a target driving force, a target acceleration, a target torque, or the like, may be determined instead of the target power.

The HV-ECU 1030 controls the engine ECU 1000, the MG-ECU 1010 and the battery ECU 1020 such that an output power from the engine ECU 1000 and an output power from the second motor generator 142 share the target power.

That is, the power output from the engine ECU 1000 and the power output from the second motor generator 142 are determined such that the sum of the power output from the engine ECU 1000 and the power output from the second motor generator 142 is equal to the target power. The engine 120 and the second motor generator 142 are controlled so as to achieve the output powers determined respectively for the engine 120 and the second motor generator 142.

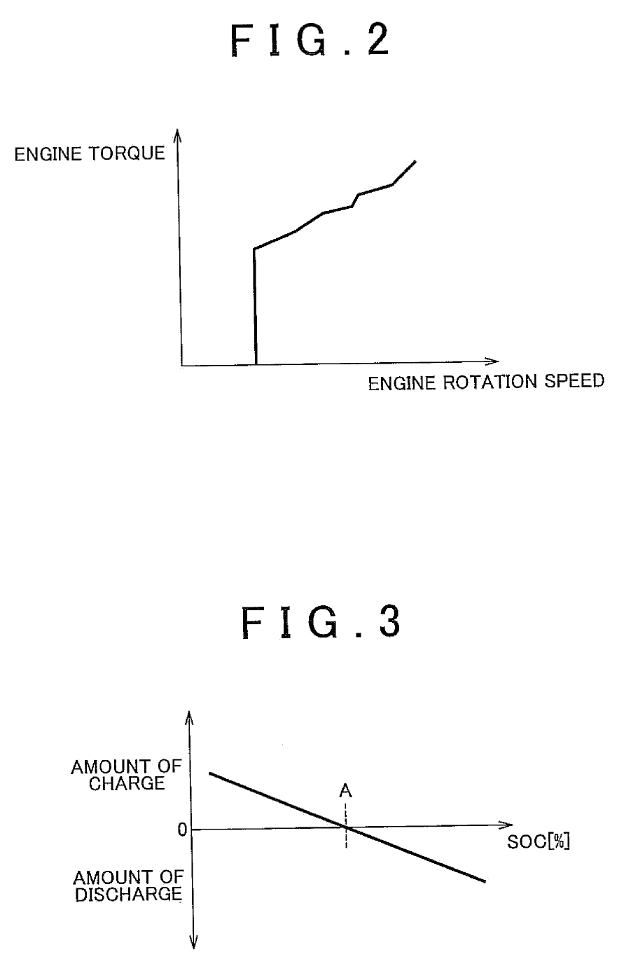

In the present embodiment, as shown in FIG. 2, the engine 120 is controlled so as to achieve engine torque and the output shaft rotation speed of the engine 120 (hereinafter, referred to as engine rotation speed), which can give appropriate fuel economy with respect to the power that should be output from the engine 120.

The engine torque and the engine rotation speed that give optimal fuel economy are, for example, determined by a developer so as to achieve optimal fuel economy within the range that satisfies various conditions related to drivability, and the like, on the basis of the results of experiments and simulations in development of the hybrid vehicle.

In addition, in the present embodiment, the HV-ECU 1030 instructs the MG-ECU 1010 and the battery ECU 1020 such that the SOC of the drive battery 220 is equal to a predetermined target value (control center value).

As shown in FIG. 3, when the SOC of the drive battery 220 is lower than a target value A, the drive battery 220 is charged. As the SOC of the drive battery 220 decreases with respect to the target value A, the rate of charge (charging electric power) to the drive battery 220 is increased.

On the other hand, when the SOC of the drive battery 220 is higher than the target value A, electric power is discharged from the drive battery 220. As the SOC of the drive battery 220 increases with respect to the target value A, the rate of discharge (discharging electric power) from the drive battery 220 is increased.

The target value of SOC of the drive battery 220 is, for example, set by the HV-ECU 1030. The target value set by the HV-ECU 1030 is transmitted to the MG-ECU 1010 and the battery ECU 1020.

The battery ECU 1020 calculates the SOC of the drive battery 220 by, for example, monitoring the discharging current from the drive battery 220, the charging current to the drive battery 220, the voltage of the drive battery 220, and the like. The HV-ECU 1030 receives a signal that indicates SOC from the battery ECU 1020.

Note that a generally known technique may be used for a method for control such that the SOC of the drive battery 220 is equal to the target value and a method of calculating the SOC, so further detailed description will not be repeated here.

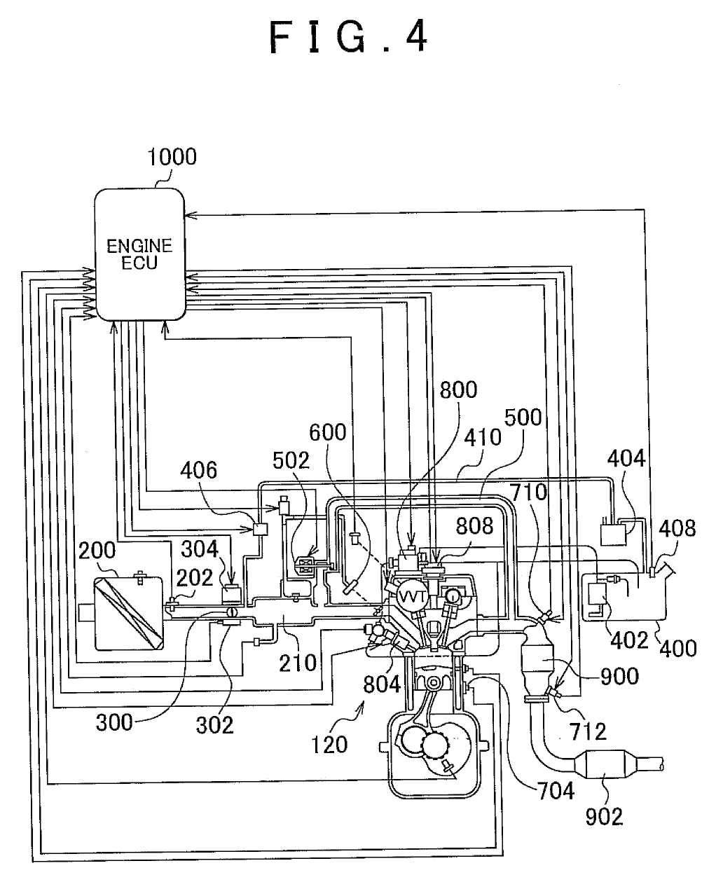

The engine 120 controlled by the engine ECU 1000 according to the present embodiment will be further described with reference to FIG. 4.

Air drawn through an air cleaner 200 is introduced into a combustion chamber of the engine 120 via an intake passage 210. An intake air flow rate is detected by an air flow meter 202, and the engine ECU 1000 receives a signal that indicates the intake air flow rate. The intake air flow rate changes on the basis of the opening degree of a throttle valve 300. The opening degree of the throttle valve 300 is changed by a throttle motor 304 that operates on the basis of a signal from the engine ECU 1000. The opening degree of the throttle valve 300 is detected by a throttle position sensor 302, and the engine ECU 1000 receives a signal that indicates the opening degree of the throttle valve 300.

Fuel is stored in a fuel tank 400, and is injected by a fuel pump 402 from an injector 804 into the combustion chamber via a high-pressure fuel pump 800. A mixture of air introduced from an intake manifold and fuel injected from the fuel tank 400 into the combustion chamber via the injector 804 is ignited by an ignition plug 808. Note that, instead of or in addition to a direct injection injector that injects fuel into the inside of a cylinder, a port injection injector that injects fuel into an intake port may be provided.

Vaporized fuel from the fuel tank 400 is trapped by a charcoal canister 404. For example, as the pressure inside the fuel tank 400 exceeds a threshold, vaporized fuel trapped by the charcoal canister 404 is, purged into the intake passage 210. The vaporized fuel purged into the intake passage 210 is drawn into the combustion chamber and is burned.

The rate of purge is controlled by a canister purge vacuum switching valve (VSV) 406. The canister purge VSV 406 is provided in a passage 410 that connects the charcoal canister 404 to the intake passage 210. As the canister purge VSV 406 is opened, vaporized fuel is purged. As the canister purge VSV 406 is closed, purge of vaporized fuel is stopped.

The canister purge VSV 406 is controlled by the engine ECU 1000. For example, the engine ECU 1000 outputs a duty signal to the canister purge VSV 406 to thereby control the opening degree of the canister purge VSV 406.

The pressure inside the fuel tank 400 is detected by a pressure sensor 408, and a signal that indicates the pressure is transmitted to the engine ECU 1000. The HV-ECU 1030 receives a signal that indicates the pressure inside the fuel tank 400 from the engine ECU 1000. Other than that, the HV-ECU 1030 receives a signal that indicates parameters of the operating state of the engine, such as engine rotation speed, via the engine ECU 1000.

Exhaust gas passes through an exhaust manifold, and is emitted to the atmosphere through a three-way catalyst converter 900 and a three-way catalyst converter 902.

Part of exhaust gas is recirculated to the intake passage 210 via an EGR pipe 500 of an exhaust gas recirculation (EGR) system. The flow rate of exhaust gas recirculated by the EGR system is controlled by an EGR valve 502. The EGR valve 502 is duty-controlled by the engine ECU 1000. The engine ECU 1000 controls the opening degree of the EGR valve 502 on the basis of various signals, such as an engine rotation speed and a signal from the accelerator position sensor 1032.

The EGR system recirculates part of exhaust gas, emitted from the engine, to an intake system, and mixes the exhaust gas with fresh air-fuel mixture to decrease combustion temperature. Thus, unburned fuel, pumping loss, nitrogen oxides (NOx), knocking, and the like, are reduced.

The concentration of oxygen in exhaust gas is detected by signals from oxygen sensors 710 and 712 for feedback control over the air-fuel ratio. The engine ECU 1000 receives a signal that indicates the concentration of oxygen, and the air-fuel ratio of air-fuel mixture is detected from the concentration of oxygen in exhaust gas.

The engine ECU 1000 calculates an optimum ignition timing on the basis of signals from the sensors, and outputs an ignition signal to the ignition plug 808. For example, the ignition timing is calculated on the basis of an engine rotation speed, a cam position, an intake air flow rate, a throttle valve opening degree, an engine coolant temperature, and the like.

The calculated ignition timing is corrected by a knock control system. As a knocking is detected by a knock sensor 704, the ignition timing is retarded by predetermined angles until the knocking stops. On the other hand, as the knocking stops, the ignition timing is advanced by predetermined angles.

In addition, in the present embodiment, the engine ECU 1000 determines whether there is a variation in air-fuel ratio among the plurality of cylinders on the basis of a fluctuation in engine rotation speed in order to detect an abnormality that the air-fuel ratio is not uniform (imbalanced).

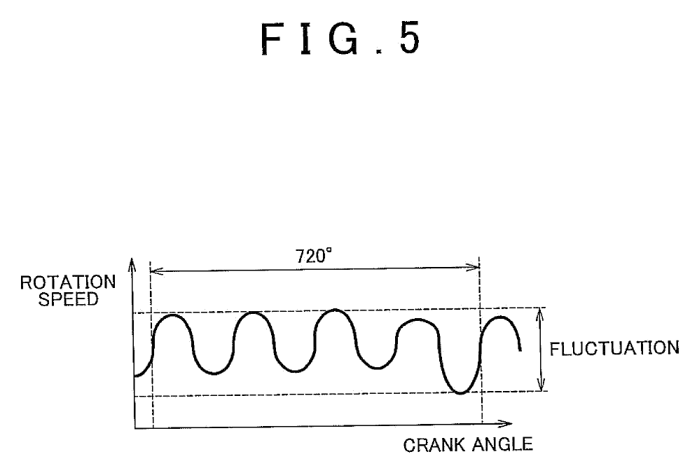

As an example, as shown in FIG. 5, when the engine rotation speed (the output shaft rotation speed of the internal combustion engine) is higher than or equal to a threshold, it is determined that there is a variation in air-fuel ratio among the plurality of cylinders. With this configuration, it is possible to detect an abnormal variation in air-fuel ratio among the plurality of cylinders when a fluctuation in the output shaft rotation speed of the internal combustion engine is higher than or equal to a threshold. The fluctuation may be, for example, obtained as the difference between the maximum and minimum of engine rotation speed within a period of a specific crank angle (for example, 720°). A method of detecting an imbalance in air-fuel ratio through a rotation fluctuation just needs to utilize a generally known technique, so the detailed description thereof is not repeated here.

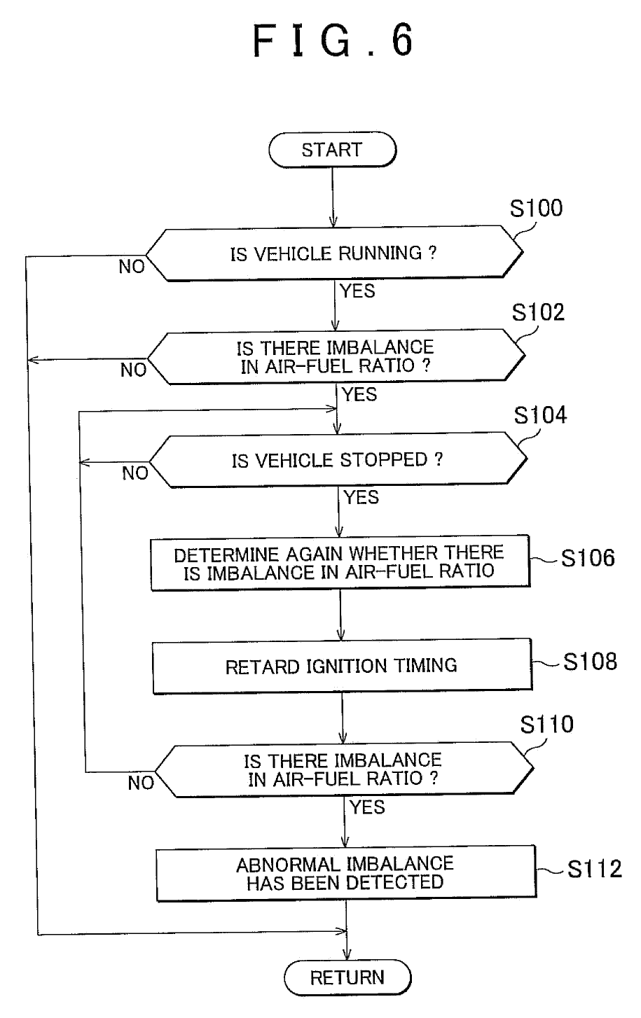

The processes executed by the engine ECU 1000 in the present embodiment will be described with reference to FIG. 6. The processes described below may be implemented by software, may be implemented by hardware or may be implemented by cooperation of software and hardware.

In step (hereinafter, step is abbreviated to “S”) 100, it is determined whether the vehicle is running. For example, when the vehicle speed is higher than or equal to a threshold, it is determined that the vehicle is running. When the vehicle is running (YES in S100), it is determined in S102 whether there is a variation in air-fuel ratio among the plurality of cylinders during operation of the engine 120. For example, when the load falls within a predetermined range or when the fluctuation of the load is smaller than or equal to a threshold, it is determined whether there is a variation in air-fuel ratio among the plurality of cylinders.

When it is determined that there is a variation in air-fuel ratio among the plurality of cylinders (YES in S102), it is determined in S104 whether the vehicle is stopped. When the vehicle is stopped (YES in S104), it is determined again in S106 whether there is a variation in air-fuel ratio among the plurality of cylinders during operation of the engine 120. That is, in the case where an imbalance in air-fuel ratio has been detected during running, even when the vehicle is in a state where the engine 120 is supposed to be stopped, the engine 120 is started and then it is determined whether there is a variation in air-fuel ratio among the plurality of cylinders.

Furthermore, in S108, while it is determined again whether there is a variation in air-fuel ratio among the plurality of cylinders, the ignition timing is retarded. For example, the ignition timing is retarded by a predetermined crank angle from a base ignition timing that is set on the basis of the load, rotation speed, and the like, of the engine 120 as parameters. The ignition timing may be retarded to a preset crank angle instead.

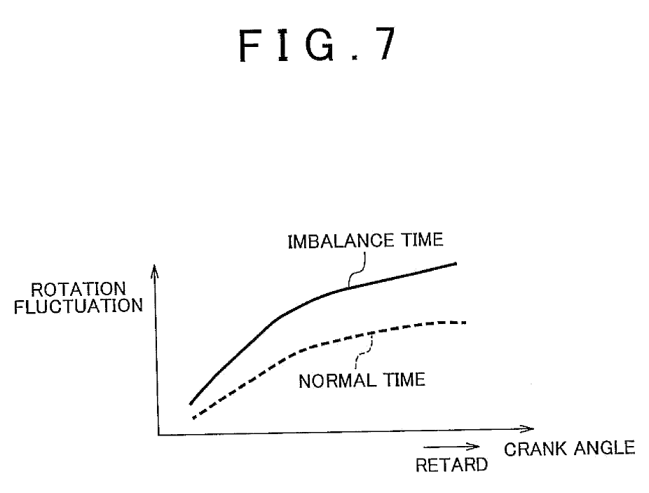

As the ignition timing is retarded, the combustion speed in each cylinder decreases. As a result, the torque obtained in the combustion stroke of the cylinder having a higher air-fuel ratio than the other cylinders further decreases. Therefore, as shown in FIG. 7, as the amount of retardation of the ignition timing increases (as the ignition timing delays), the difference between a fluctuation in engine rotation speed at the time when the air-fuel ratio is uniform, indicated by the broken line, and a fluctuation in engine rotation speed at the time when the air-fuel ratio is not uniform, indicated by the solid line, tends to increase. In addition, as the amount of retardation of the ignition timing increases, a fluctuation in engine rotation speed at the time when the air-fuel ratio is not uniform tends to increase. Therefore, an imbalance in air-fuel ratio may be remarkably indicated by the rotation fluctuation. As a result, it is possible to accurately determine an abnormal imbalance in air-fuel ratio.

Referring back to FIG. 6, when it is determined that there is a variation in air-fuel ratio among the plurality of cylinders (YES in S110) in a state where the ignition timing is retarded, an imbalance in air-fuel ratio has been detected in S112.

According to the present embodiment, by determining whether there is a variation in air-fuel ratio among the cylinders multiple times, it is possible to suppress erroneous detection of an abnormality that the air-fuel ratio is not uniform. In addition, by increasing the rotation fluctuation during a stop of the vehicle, it is possible to suppress deterioration of running performance.

Exhaust gas may be returned to the plurality of cylinders or the amount of exhaust gas returned to the cylinders may be increased by the EGR system or increasing the overlap amount between each intake valve and the corresponding exhaust valve instead of or in addition to retarding the ignition timing. With this configuration, the combustion temperature is decreased by returning exhaust gas to the plurality of cylinders. As a result, for example, the torque obtained in the combustion stroke of the cylinder having a higher air-fuel ratio than the other cylinders is further decreased. Therefore, a fluctuation in engine rotation speed (output shaft rotation speed of the internal combustion engine) is increased.

Furthermore, the air-fuel ratio in each cylinder may be increased instead of or in addition to retarding the ignition timing. That is, the fuel injection amount from the injector in each cylinder may be reduced. With this configuration, by increasing the air-fuel ratio in each cylinder, the air-fuel ratio is further increased in the cylinder in which the fuel injection amount is insufficient. As a result, the torque obtained in the combustion stroke of that cylinder is further decreased. Therefore, a fluctuation in engine rotation speed (output shaft rotation speed of the internal combustion engine) is increased.

In any case, the torque obtained in the combustion stroke of the cylinder having a higher air-fuel ratio than the other cylinders is further decreased. Therefore, a fluctuation in engine rotation speed is increased.

The embodiment described above is illustrative and not restrictive in all respects. The scope of the invention is defined by the appended claims rather than the above description. The scope of the invention is intended to encompass all modifications within the scope of the appended claims and equivalents thereof.

What is claimed is:

1. An abnormality determination apparatus for an internal combustion engine having a plurality of cylinders, comprising:
a fluctuation increasing unit that increases a fluctuation in output shaft rotation speed of the internal combustion engine; and
a determination unit that determines whether there is a variation in air-fuel ratio among the plurality of cylinders based on the fluctuation increased by the fluctuation increasing unit.

2. The abnormality determination apparatus according to claim 1, wherein the determination unit determines that there is a variation in air-fuel ratio among the plurality of cylinders when the fluctuation in output shaft rotation speed of the internal combustion engine is larger than or equal to a threshold.

3. The abnormality determination apparatus according to claim 1, wherein the fluctuation increasing unit retards ignition timing in the internal combustion engine to increase the fluctuation in output shaft rotation speed of the internal combustion engine.

4. The abnormality determination apparatus according to claim 1, wherein the fluctuation increasing unit returns exhaust gas, emitted from the internal combustion engine, to the plurality of cylinders to increase the fluctuation in output shaft rotation speed of the internal combustion engine.

5. The abnormality determination apparatus according to claim 1, wherein the fluctuation increasing unit increases an air-fuel ratio in each of the cylinders to increase the fluctuation in output shaft rotation speed of the internal combustion engine.

6. The abnormality determination apparatus according to claim 1, wherein
the determination unit determines whether there is a variation in air-fuel ratio among the plurality of cylinders,
when the determination unit determines that there is a variation in air-fuel ratio among the plurality of cylinders, the fluctuation increasing unit increases the fluctuation in output shaft rotation speed of the internal combustion engine, and
the determination unit then determines whether there is a variation in air-fuel ratio among the plurality of cylinders, based on the fluctuation increased by the fluctuation increasing unit.

7. The abnormality determination apparatus according to claim 1, wherein
the internal combustion engine is mounted on a vehicle,
the determination unit determines whether there is a variation in air-fuel ratio among the plurality of cylinders during running of the vehicle,
when the determination unit determines that there is a variation in air-fuel ratio among the plurality of cylinders during running of the vehicle, the determination unit determines whether there is a variation in air-fuel ratio among the plurality of cylinders during a stop of the vehicle, and
after the determination unit has determined that there is a variation in air-fuel ratio among the plurality of cylinders during running of the vehicle, the fluctuation increasing unit increases the fluctuation in output shaft rotation speed of the internal combustion engine.
